(19) United States
(12) Patent Application Publication
(10) Pub. No.: US 2021/0051228 A1
(43) Pub. Date: Feb. 18, 2021

(54) TELEPHONE CONTROL SYSTEM, TELEPHONE CONTROL METHOD, AND PROGRAM

(71) Applicant: NEC CORPORATION, Tokyo (JP)

(72) Inventor: Masato YOSHIKAWA, Tokyo (JP)

(73) Assignee: NEC CORPORATION, Tokyo (JP)

(21) Appl. No.: 16/967,860

(22) PCT Filed: Feb. 8, 2019
(86) PCT No.: PCT/JP2019/004587

§ 371 Date: Aug. 6, 2020

(30) Foreign Application Priority Data
Feb. 8, 2018 (JP) 2018-020965

(51) Int. Cl. H04M 3/42; G06K 9/00

(52) U.S. Cl. CPC H04M 3/42263; H04M 3/42365; H04M 3/42348; H04M 2201/41; H04M 3/42059; H04M 2203/551; G06K 9/00288

(57) ABSTRACT

A telephone control system (1) is provided with a person determination unit (110) that determines a target person based on a caller number included in a call, a position determination unit (120) that determines a position of the target person using presence information of a person in a facility, and a control unit (130) that controls a telephone allowed to ring based on the position of the target person determined by the position determination unit (120).

### TECHNICAL FIELD

The present invention relates to a technique of controlling an incoming call to a telephone.

### BACKGROUND ART

An example of a technique of controlling an incoming call to a telephone is disclosed in Patent Document 1 below. Patent Document 1 below discloses a technique of causing a telephone corresponding to a caller telephone number to ring with reference to a table for registering a ringing telephone corresponding to each caller telephone number. Accordingly, unnecessary ringing of the telephone installed in an office can be suppressed.

### RELATED DOCUMENT

### Patent Document

[Patent Document 1] Japanese Patent Application Publication No. 2001-177604

### SUMMARY OF THE INVENTION

### Technical Problem

In recent years, a non-territorial office has attracted attention as a new office layout style. There is no fixed seat for each individual and each individual freely selects a seat to perform work in the non-territorial office. In the non-territorial office, since the seat used by each individual may change with time, the effect of “suppressing the unnecessary ringing” may not be obtained even when the caller telephone number and the telephone are in correspondence with each other

The present invention has been made in view of the above problems. An object of the present invention is to provide a technique of suppressing unnecessary ringing of a telephone regardless of an office layout style.

### Solution to Problem

According to the present invention, there is provided a telephone control system including

a person determination unit that determines a target person based on a caller number included in a call,

a position determination unit that determines a position of the target person using presence information of a person in a facility, and

a control unit that controls a telephone to ring, based on the position of the target person determined by the position determination unit.

According to the present invention, there is provided a telephone control method executed by at least one computer, the method including

determining a target person based on a caller number included in a call;

determining a position of the target person using presence information of a person in a facility; and

controlling a telephone to ring, based on the position of the target person determined.

According to the present invention, there is provided a program for causing a computer to execute the above telephone control method.

### Advantageous Effects of Invention

According to the present invention, it is possible to suppress the unnecessary ringing of the telephone regardless of the office layout style.

### BRIEF DESCRIPTION OF THE DRAWINGS

The above object and other objects, features and advantages will become more apparent from the following preferred example embodiments and accompanying drawings.

FIG. 1 is a block diagram conceptually showing a configuration of a telephone control system according to a first example embodiment.

FIG. 2 is a block diagram illustrating a hardware configuration of the telephone control system according to the first example embodiment.

FIG. 3 is a flowchart showing an example of a process executed by the telephone control system according to the first example embodiment.

FIG. 4 is a flowchart showing an example of the process executed by the telephone control system according to the first example embodiment.

FIG. 5 is a flowchart showing an example of the process executed by the telephone control system according to the first example embodiment.

FIG. 6 is a table showing an example of information defining a target person for each caller number.

FIG. 7 is a table showing an example of presence information.

FIG. 8 is a block diagram conceptually showing a configuration of a telephone control system according to a second example embodiment.

FIG. 9 is a block diagram illustrating a hardware configuration of the telephone control system according to the second example embodiment.

FIG. 10 is a block diagram conceptually showing a configuration of a telephone control system according to a third example embodiment.

### DESCRIPTION OF EMBODIMENTS

Hereinafter, example embodiments of the present invention will be described with reference to drawings. Note that, in all the drawings, the same reference numerals will be assigned to the same components and description thereof will not be repeated as appropriate. Unless otherwise specified, each block represents a configuration of a functional unit, not a configuration of a hardware unit in each block diagram.

### First Example Embodiment

[Functional Configuration]

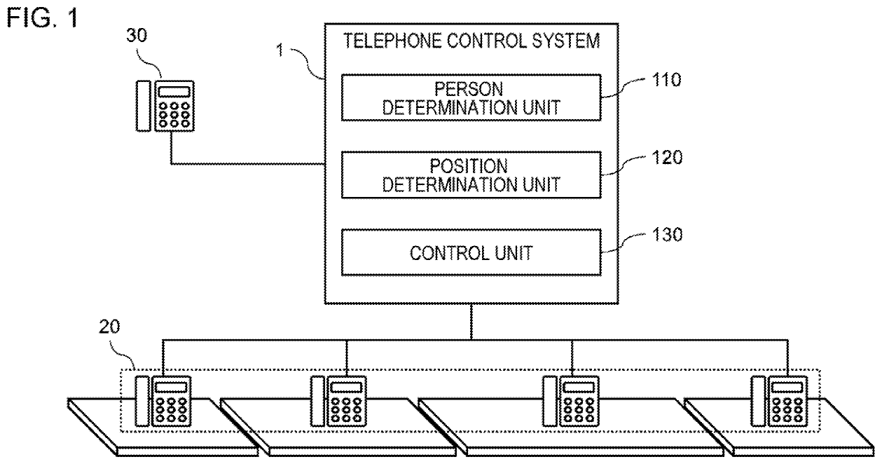

FIG. 1 is a block diagram conceptually showing a configuration of a telephone control system 1 according to a first example embodiment. As shown in FIG. 1, a telephone 20 and a telephone 30 are connected to the telephone control system 1. The telephone 20 is a telephone (hereinafter also referred to as “in-facility telephone”) provided in a facility such as an office. The telephone 30 is a telephone (hereinafter also referred to as “external telephone”) that can communicate with the in-facility telephone 20 through a public line network or an Internet Protocol (IP) network. Although not shown, a plurality of external telephones 30 may be connected to the telephone control system 1. Hereinafter, functional configuration units of the telephone control system 1 according to the present invention will be described.

As shown in FIG. 1, the telephone control system 1 according to the present invention includes a person determination unit 110, a position determination unit 120, and a control unit 130. When the telephone control system 1 receives a call from the external telephone 30, the person determination unit 110 determines a person (hereinafter also referred to as “target person”) required to respond to the call based on a caller number included in the call. Here, the telephone control system 1 holds in advance information (hereinafter also referred to as “target person information”) defining the target person for each caller number. The person determination unit 110 can determine the target person corresponding to the caller number included in the received call with reference to the information. When the target person is determined by the person determination unit 110, the position determination unit 120 determines a position of the target person using presence information of a person in the facility. The presence information includes at least information that can identify a user using each seat provided in the facility. The position determination unit 120 can determine a seat used by the target person (that is, position of target person) determined by the person determination unit 110 with reference to the presence information. The control unit 130 controls the in-facility telephone 20 to ring based on the position of the target person determined by the position determination unit 120. As an example, the control unit 130 can determine an in-facility telephone 20 closest to the target person based on the position of the target person determined by the position determination unit 120 and cause only the in-facility telephone 20 to ring.

As described above, the target person corresponding to the caller number included in the call is determined in the present example embodiment. The in-facility telephone 20 to ring is controlled based on the position of the target person. Accordingly, it is possible to obtain an effect of suppressing unnecessary ringing of the in-facility telephone 20 even in a non-territorial office where a position of each person may change with time.

Hereinafter, the present example embodiment will be described in more detail.

[Hardware Configuration]

Each functional configuration unit of the telephone control system 1 may be realized by hardware (for example, a hard-wired electronic circuit) that realizes each functional configuration unit, or a combination of hardware and software (for example, electronic circuit and a program for controlling the circuit). Hereinafter, a case where each functional configuration unit of the telephone control system 1 is realized by the combination of hardware and software will be further described.

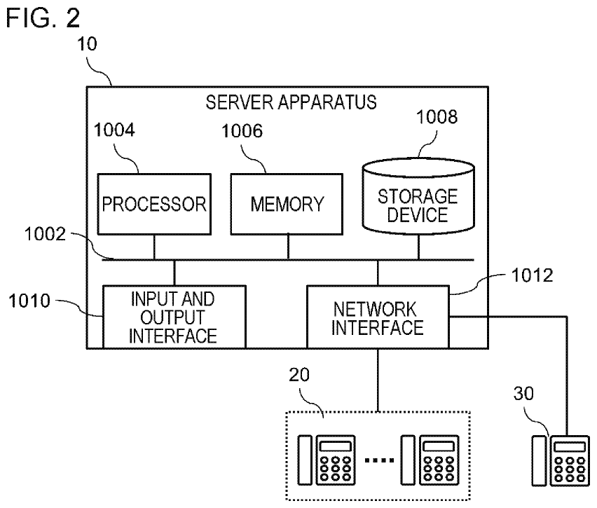

FIG. 2 is a block diagram illustrating a hardware configuration of the telephone control system 1 according to the first example embodiment. In the example of FIG. 2, a server apparatus 10 is provided with each functional configuration unit of the telephone control system 1. The server apparatus 10 includes a bus 1002, a processor 1004, a memory 1006, a storage device 1008, an input and output interface 1010, and a network interface 1012.

The bus 1002 is a data transmission path through which the processor 1004, the memory 1006, the storage device 1008, the input and output interface 1010, and the network interface 1012 mutually transmit and receive data. However, a method of mutually connecting the processor 1004 and the like is not limited to a bus connection.

The processor 1004 is a processor realized by a central processing unit (CPU), a graphics processing unit (GPU), or the like.

The memory 1006 is a main storage formed by a random access memory (RAM) or the like.

The storage device 1008 is an auxiliary storage device formed by a hard disk drive (HDD), a solid state drive (SSD), a memory card, a read only memory (ROM), or the like. The storage device 1008 stores a program module that realizes each of the functions (person determination unit 110, position determination unit 120, control unit 130, and the like) of the telephone control system 1. The processor 1004 reads the program modules in the memory 1006 and executes the modules to realize respective functions corresponding to the program modules. The storage device 1008 may store the target person information, the presence information, or the like.

The input and output interface 1010 is an interface for connecting the server apparatus 10 and various input and output devices. For example, an input apparatus such as a mouse and a keyboard and an output apparatus such as a display are connected to the input and output interface 1010.

The network interface 1012 is an interface for connecting the server apparatus 10 to a network. This network is, for example, a local area network (LAN) or a wide area network (WAN). A method of connecting the network interface 1012 to the network may be a wireless connection or a wired connection. The server apparatus 10 receives the call from the external telephone 30 to the in-facility telephone 20 through the network interface 1012. The server apparatus 10 transfers the received call to the in-facility telephone 20 through the network interface 1012.

Note that the configuration of the telephone control system 1 illustrated in FIG. 2 is merely an example and the configuration of the telephone control system 1 is not limited to the configuration of FIG. 2.

[Process Flow]

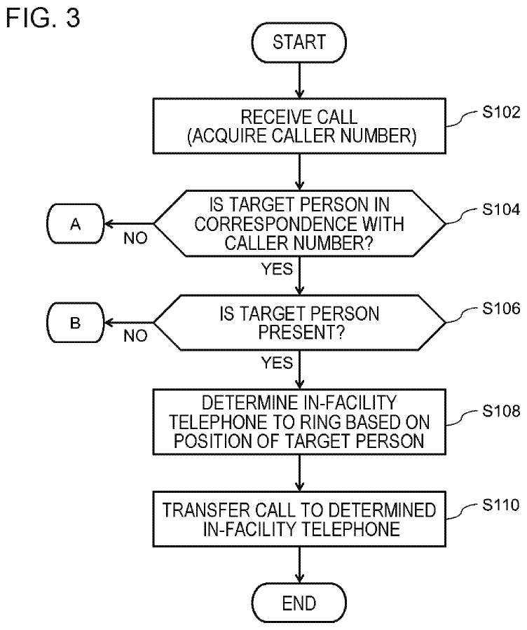

Hereinafter, a specific operation of the telephone control system 1 according to the present example embodiment will be illustrated with reference to FIGS. 3 to 5. FIGS. 3 to 5 are flowcharts illustrating an example of a process executed by the telephone control system 1 according to the first example embodiment.

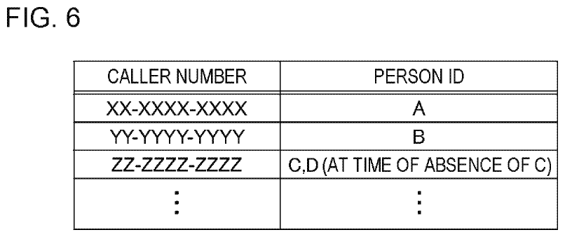

First, when the telephone control system 1 receives the call from the external telephone 30, the person determination unit 110 acquires a caller number included in the call (S102). The person determination unit 110 checks whether or not the target person is in correspondence with the acquired caller number (S104). As an example, the person determination unit 110 refers to information (for example, FIG. 6) defining the target person for each caller number stored in the storage device 1008 or the like, and thus can determine whether or not the target person is in correspondence with the caller number acquired in the process of S102. FIG. 6 is a table showing an example of the information defining the target person for each caller number. The person determination unit 110 can decide that a target person of a call including a caller number “XX-XXXX-XXXX” is “A” based on the information illustrated in FIG. 6. The person determination unit 110 can decide that a target person of a call including a caller number “YY-YYYY-YYYY” is “B” based on the information illustrated in FIG. 6. The person determination unit 110 can decide that a target person of a call including a caller number “ZZ-ZZZZ-ZZZZ” is “C” (“D” when C is absent) based on the information illustrated in FIG. 6. In a case where the target person is in correspondence with the caller number (S104: YES), the person determination unit 110 acquires information indicating the target person (for example, person identifier (ID) assigned to each individual). Accordingly, the target person is determined. The person determination unit 110 passes the information indicating the target person to the position determination unit 120.

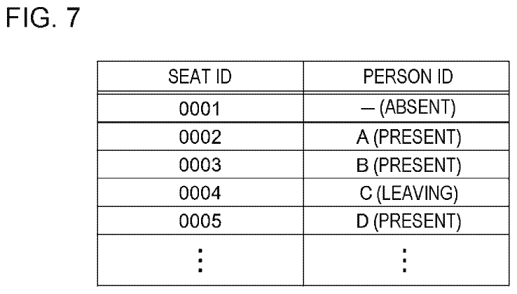

The position determination unit 120 checks a presence state of the target person determined by the person determination unit 110 with reference to the presence information (for example, FIG. 7) based on the information indicating the target person acquired from the person determination unit 110 (S106). FIG. 7 is a table showing an example of the presence information. The position determination unit 120 can decide that a user using a seat having a seat ID “0002” is “A” based on the information illustrated in FIG. 7. The position determination unit 120 can decide that a user using a seat having a seat ID “0003” is “B” based on the information illustrated in FIG. 7. The position determination unit 120 can decide that a user using a seat having a seat ID “0004” is “C” based on the information illustrated in FIG. 7. The position determination unit 120 can decide that a user using a seat having a seat ID “0005” is “D” based on the information exemplified in FIG. 7. The position determination unit 120 can decide that there is no user using a seat having a seat ID “0001” based on the information illustrated in FIG. 7. In a case where the target person is present (S106: YES), the position determination unit 120 passes information indicating the position of the target person to the control unit 130. For example, the position determination unit 120 passes information indicating the seat used by the target person to the control unit 130 as the information indicating the position of the target person.

The control unit 130 determines the in-facility telephone 20 to ring based on the information indicating the position of the target person (S108). As an example, the control unit 130 can decide the in-facility telephone 20 using a result obtained by comparing the information indicating the position of the target person acquired from the position determination unit 120 with data including position information of the in-facility telephone 20. For example, the control unit 130 compares the position of the target person acquired from the position determination unit 120 with the position information of the in-facility telephone 20 and thus can determine the in-facility telephone 20 closest to the target person as the in-facility telephone 20 to ring. In addition to the above, information indicating an in-facility telephone 20 closest to each seat is prepared in advance in the storage device 1008 or the like, and the control unit 130 may determine the in-facility telephone 20 closest to the seat used by the target person using the information indicating the seat. The control unit 130 transfers the call to the determined in-facility telephone 20 (S110). Accordingly, it is possible to aim at and cause the in-facility telephone 20 closest to the target person to ring.

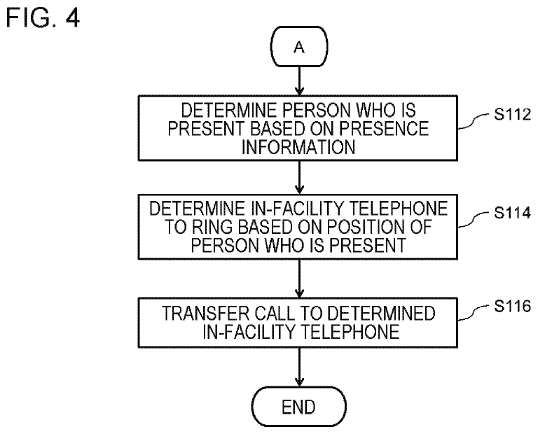

Returning to the determination process of S104, in a case where the target person is not in correspondence with the caller number (S104), the person determination unit 110 cannot determine the target person corresponding to the caller number. In this case, the telephone control system 1 may execute a process as shown in FIG. 4. First, the position determination unit 120 checks the presence information to determine a person who is currently present (S112). The position determination unit 120 decides the in-facility telephone 20 to ring based on a position of the determined person who is present (S114). For example, in a case where the presence information illustrated in FIG. 7 is stored in the storage device 1008 or the like, the position determination unit 120 can determine the persons A, B, and D as the persons who are present based on the presence information. The position determination unit 120 respectively determines an in-facility telephone 20 closest to a position of the person A (seat ID “0002”), an in-facility telephone 20 closest to a position of the person B (seat ID “0003”), and an in-facility telephone 20 closest to a position of the person D (seat ID “0005”). The position determination unit 120 transfers the call to the determined in-facility telephone 20 (S116). In this case, the in-facility telephones 20 closest to the persons A, B, and D ring all at once. Accordingly, in a case where the target person required to respond a call from a certain caller number is not decided, it is possible to cause only the in-facility telephone 20 closest to any person who is currently present to ring.

In a case where the person determination unit 110 cannot determine the target person, the telephone control system 1 may execute the following process. First, the person determination unit 110 notifies the control unit 130 that the target person cannot be determined. The control unit 130 causes a representative in-facility telephone 20 set in advance to ring in response to receiving the notification. By doing this, it is possible to limit the in-facility telephone 20 to ring in the case where the target person required to respond to the call from the certain caller number is not decided.

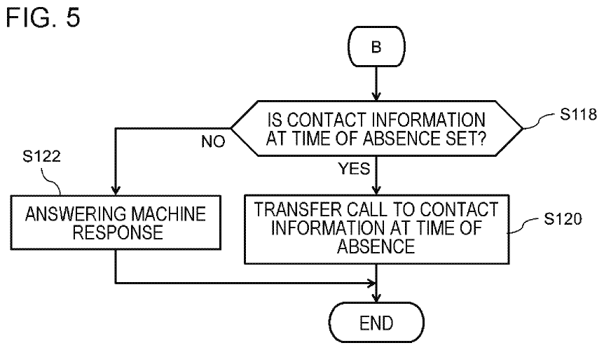

Returning to the determination process of S106, in a case where the target person is not present (for example, at the time of going out or temporarily leaving), the telephone control system 1 may execute a process as shown in FIG. 5. First, the position determination unit 120 notifies the control unit 130 that the target person is not present. In response to this notification, the control unit 130 checks whether or not contact information (for example, contact information of mobile terminal) at the time of the absence of the target person is set in advance (S118). The contact information at the time of the absence of the target person is registered in advance in, for example, the storage device 1008. In a case where the contact information at the time of the absence is set (S118: YES), the control unit 130 transfers the call to the contact information (S120). In a case where the contact information at the time of the absence is not set (S118: NO), the control unit 130 executes a response with an answering machine or the like (S122). At this time, the control unit 130 does not cause any of the in-facility telephones 20 to ring. By doing this, it is possible to prevent the in-facility telephone 20 from ringing unnecessarily in the case where the target person is absent.

### Second Example Embodiment

The present example embodiment has the same configuration as the first example embodiment except for the following points.

[Functional Configuration]

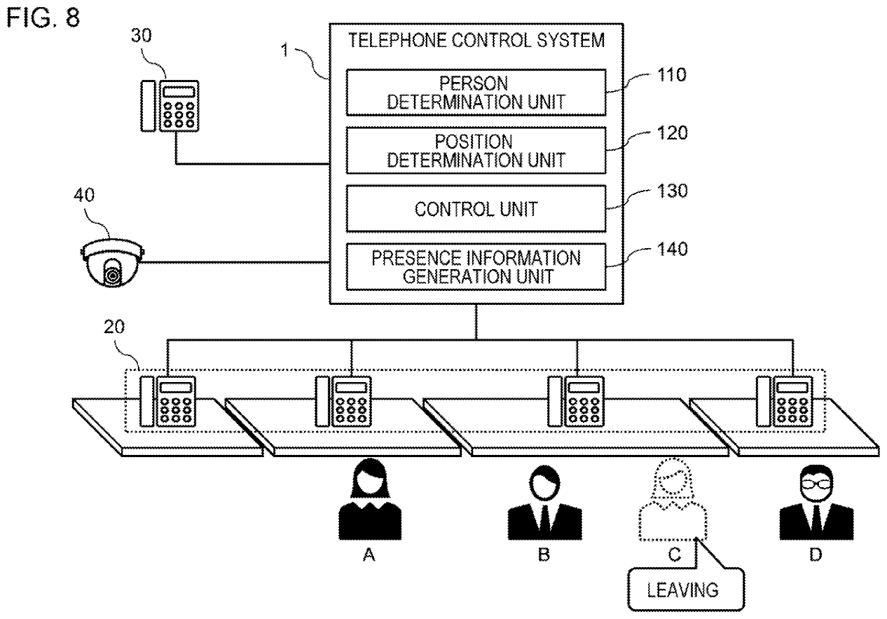

FIG. 8 is a block diagram conceptually showing a configuration of the telephone control system 1 according to the second example embodiment. As shown in FIG. 8, the telephone control system 1 according to the present example embodiment is provided with a presence information generation unit 140 in addition to the configuration of the first example embodiment.

The presence information generation unit 140 according to the present example embodiment generates presence information used by the position determination unit 120. For example, in a case where a presence situation of each person is a state as shown in FIG. 8, the presence information generation unit 140 can generate the presence information as illustrated in FIG. 7. The presence information generation unit 140 stores the generated presence information in the storage device 1008 or the like.

As an example, the presence information generation unit 140 can generate or update the presence information based on a result of face recognition using an image of each person in the facility. The image of each person in the facility is generated by, for example, an imaging apparatus 40 provided in the facility. The imaging apparatus 40 is installed, for example, at the upper part of the floor such that a plurality of persons using the seats are included in an imaging range. The imaging apparatus 40 may be a web camera or the like provided on each seat. The presence information generation unit 140 analyzes the image generated by the imaging apparatus 40 and thus can determine the person included in the image. For example, the presence information generation unit 140 detects the person (face of person) in the image using a known person recognition algorithm. The presence information generation unit 140 compares a detection area of the person with position information in the image of each seat included in the imaging range of the imaging apparatus 40 and thus can identify which seat is taken by the person. The position information in the image of each seat included in the imaging range of the imaging apparatus 40 is stored in the storage device 1008 in advance, for example. Note that, in a case where the imaging apparatus 40 is the web camera or the like provided in each seat, the presence information generation unit 140 can determine a seat corresponding to the imaging apparatus 40 using identification information of the imaging apparatus 40 that generates the image used for the analysis.

The presence information generation unit 140 may generate or update the presence information based on information of a predetermined operation (such as login operation or change operation of presence state) executed on a terminal used by each person. In this case, the presence information generation unit 140 receives the information of the predetermined operation together with the identification information of each person and thus can generate or update the presence information.

[Hardware Configuration]

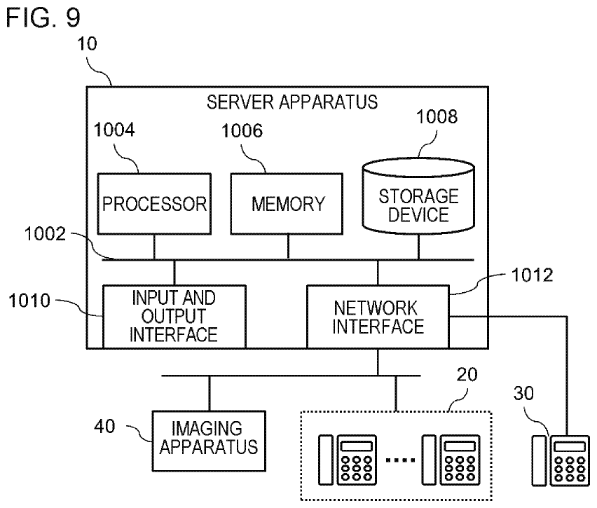

FIG. 9 is a block diagram illustrating a hardware configuration of the telephone control system 1 according to the second example embodiment. The storage device 1008 according to the present example embodiment further stores a program module that realizes the function of the presence information generation unit 140 described above. The processor 1004 reads out the program module in the memory 1006 and executes the module to realize the function of the presence information generation unit 140. In the example of FIG. 9, the imaging apparatus 40 is further connected to the network interface 1012. The presence information generation unit 140 communicates with the imaging apparatus 40 through the network interface 1012 and thus can acquire the image generated by the imaging apparatus 40.

As described above, according to the present example embodiment, it is possible for the telephone control system 1 to hold real-time presence information. Accordingly, it is possible to prevent the telephone control system 1 from transferring the call received from the external telephone 30 to the target person at an incorrect timing.

### Third Example Embodiment

The present example embodiment is the same as the above first and second example embodiments except for the following points.

[Functional Configuration]

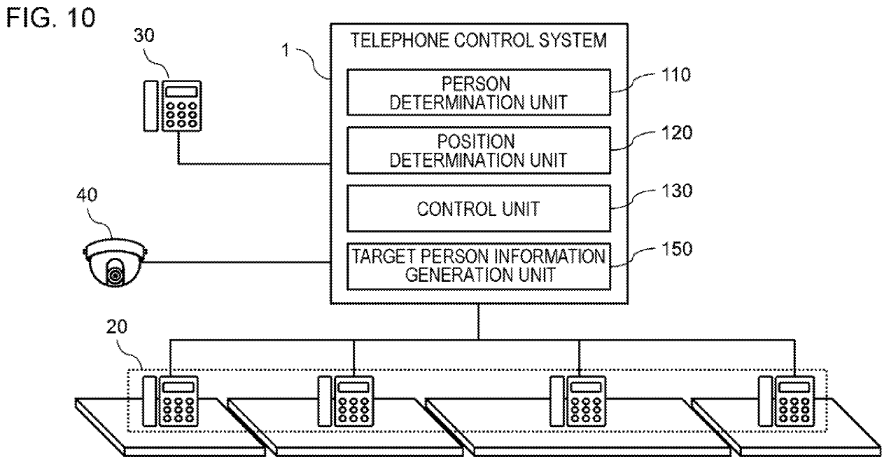

FIG. 10 is a block diagram conceptually showing a configuration of the telephone control system 1 according to the third example embodiment. As shown in FIG. 10, the telephone control system 1 according to the present example embodiment is further provided with a target person information generation unit 150. Note that the telephone control system 1 according to the present example embodiment may further include the presence information generation unit 140 described in the second example embodiment.

The target person information generation unit 150 generates information (target person information) defining the target person for each caller number based on a record of responding to a person related to each call number. The target person information generation unit 150 stores the generated target person information in, for example, the storage device 1008. The person determination unit 110 determines a target person corresponding to the caller number included in the call received from the external telephone 30 based on the target person information generated by the target person information generation unit 150.

<Specific Example of Process of Target Person Information Generation Unit 150>

In the present example embodiment, the target person information generation unit 150 collects call records (such as caller number, responder, and duration of a call) for each call and accumulates the records in the storage device 1008 to generate a history of a responder for each caller number. Here, the “responder” refers to a person who responds to the call from the external telephone 30 and talks on the phone with the caller.

Here, the target person information generation unit 150 performs voiceprint recognition using a call voice and thus can identify the responder. In this case, the target person information generation unit 150 operates as follows, for example. First, when the control unit 130 transfers the call from the external telephone 30 to the in-facility telephone 20, the target person information generation unit 150 acquires information indicating the in-facility telephone 20 of a transfer destination from the control unit 130. The target person information generation unit 150 acquires call voice data on the in-facility telephone 20 indicated by the information acquired from the control unit 130. The target person information generation unit 150 collates the acquired call voice data with voiceprint data registered in a database in advance. The target person information generation unit 150 determines a person identified from a result of collating the voiceprint therewith as the responder.

The target person information generation unit 150 may perform the face recognition instead of the voiceprint recognition. In this case, the target person information generation unit 150 operates as follows. First, the target person information generation unit 150 determines an imaging apparatus 40 including the in-facility telephone 20 indicated by the information acquired from the control unit 130 in the imaging range. The target person information generation unit 150 analyzes the image generated by the determined imaging apparatus 40 to detect a person (face of person) operating the in-facility telephone 20 indicated by the information acquired from the control unit 130. The target person information generation unit 150 collates the detected person (face of person) with information registered in the database in advance. The target person information generation unit 150 determines a person identified from a result of collating the face image therewith as the responder.

The target person information generation unit 150 can generate the target person information based on the history of the responder for each caller number accumulated in the storage device 1008 or the like. As an example, the target person information generation unit 150 computes a statistical value (for example, total value or average value) of durations of a call for each responder from the history of the responders for each caller number. The target person information generation unit 150 decides the target person based on the computed statistical value of the durations of a call for each responder. For example, the target person information generation unit 150 decides a responder having the largest statistical value of the durations of a call with a certain caller number as the target person of the caller number. The target person information generation unit 150 may decide the target person for each caller number using the number of calls for each responder instead of the duration of a call for each responder.

The target person information generation unit 150 may determine the target person for each caller number using a history of email communication with the person related to the caller number. As an example, the target person information generation unit 150 operates as follows. First, the target person information generation unit 150 acquires the email communication history from an email server (not shown), for example. The target person information generation unit 150 extracts a sender address and a recipient address of each email from the acquired email communication history. The target person information generation unit 150 can determine a caller number and a target person to be in correspondence with the caller number from the sender address and the recipient address of each email. For example, the target person information generation unit 150 can determine the caller number corresponding to the sender address or the recipient address using information in which the caller number and an email address of the person related to the caller number are in correspondence with each other. The target person information generation unit 150 compares the sender address and the recipient address of each email with the email address assigned to the person in the facility and thus can determine the target person related to the sender address or the recipient address as the target person. Note that the target person information generation unit 150 may compute a statistical value of the number of times of communication for each person from the email communication history and determine a person having the largest statistical value as the target person.

[Hardware Configuration]

The telephone control system 1 according to the present example embodiment has the same hardware configuration as the first and second example embodiments (for example, FIGS. 2 and 9). The storage device 1008 according to the present example embodiment further stores a program module that realizes the function of the target person information generation unit 150 described above. The processor 1004 reads out the program module in the memory 1006 and executes the module to realize the function of the target person information generation unit 150.

As described above, in the present example embodiment, the information (target person information) defining the target person for each caller number is generated based on the record of responding to the person related to each call number. Accordingly, the accuracy of a selective ringing setting of the in-facility telephone 20 improves as the number of calls from the external telephone 30 increases.

As described above, the example embodiments of the present invention have been described with reference to the drawings. However, the example embodiments are merely illustrations of the present invention, and various configurations other than the above may be employed.

The plurality of steps (processes) are described in order in the plurality of flowcharts used in the above description. However, an execution order of the steps executed in each example embodiment is not limited to the described order. In each example embodiment, the order of the illustrated steps may be changed in a range that does not hinder the contents. The above example embodiments may be combined in a range where the contents do not conflict with each other.

Some or all of the above example embodiments may be described as in the following supplementary notes, but are not limited thereto.

1. A telephone control system including:

a person determination unit that determines a target person based on a caller number included in a call;

a position determination unit that determines a position of the target person using presence information of a person in a facility; and

a control unit that controls a telephone allowed to ring, based on the position of the target person determined by the position determination unit.

2. The telephone control system according to 1, further including:

a presence information generation unit that generates the presence information based on a result of face recognition using an image of the person in the facility.

3. The telephone control system according to 1 or 2, further including:

a target person information generation unit that generates target person information defining a target person for each caller number based on a record of responding to a person related to each caller number,

wherein the person determination unit determines the target person corresponding to the caller number included in the call based on the target person information.

4. The telephone control system according to 3,

wherein the target person information generation unit generates the target person information based on a history of a responder for each caller number.

5. The telephone control system according to 4,

wherein the target person information generation unit decides the target person for each caller number based on a statistical value of durations of a call for each responder obtained from the history.

6. The telephone control system according to 4,

wherein the target person information generation unit decides the target person for each caller number based on a statistical value of the number of calls for each responder obtained from the history.

7. The telephone control system according to any one of 4 to 6,

wherein the target person information generation unit determines the responder to be in correspondence with a caller number based on a result of voiceprint recognition using a call voice.

8. The telephone control system according to any one of 4 to 6,

wherein the target person information generation unit determines the responder to be in correspondence with a caller number based on an analysis result of a face image of a person.

9. The telephone control system according to 3,

wherein the target person information generation unit generates the target person information using a history of email communication with the person related to each caller number.

10. The telephone control system according to any one of 1 to 9,

wherein the position determination unit determines a position of another person who is present based on the presence information in a case where the target person is not determined by the person determination unit, and

wherein the control unit controls the telephone allowed to ring, based on the position of the other person who is present determined by the position determination unit.

11. The telephone control system according to any one of 1 to 9,

wherein the control unit causes a representative telephone set in advance to ring in a case where the target person is not determined by the person determination unit.

12. The telephone control system according to any one of 1 to 11,

wherein the control unit decides the telephone allowed to ring using a comparison result of the position of the target person determined by the position determination unit and data including position information of a telephone in the facility.

13. The telephone control system according to any one of 1 to 12,

wherein the control unit does not cause any telephone to ring in a case where the presence information corresponding to the target person indicates absence.

14. A telephone control method executed by a computer, the method including:

determining a target person based on a caller number included in a call;

determining a position of the target person using presence information of a person in a facility; and

controlling a telephone allowed to ring based on the position of the target person determined.

15. The telephone control method executed by a computer according to 14, the method further including:

generating the presence information based on a result of face recognition using an image of the person in the facility.

16. The telephone control method executed by a computer according to 14 or 15, the method further including:

generating target person information defining a target person for each caller number based on a record of responding to a person related to each caller number; and

determining the target person corresponding to the caller number included in the call based on the target person information.

17. The telephone control method executed by a computer according to 16, the method further including:

generating the target person information based on a history of a responder for each caller number.

18. The telephone control method executed by a computer according to 17, the method further including:

deciding the target person for each caller number based on a statistical value of durations of a call for each responder obtained from the history.

19. The telephone control method executed by a computer according to 17, the method further including:

deciding the target person for each caller number based on a statistical value of the number of calls for each responder obtained from the history.

20. The telephone control method executed by a computer according to any one of 17 to 19, the method further including:

determining the responder to be in correspondence with a caller number based on a result of voiceprint recognition using a call voice.

21. The telephone control method executed by a computer according to any one of 17 to 19, the method further including:

determining the responder to be in correspondence with a caller number based on an analysis result of a face image of a person.

22. The telephone control method executed by a computer according to 16, the method further including:

generating the target person information using a history of email communication with the person related to each caller number.

23. The telephone control method executed by a computer according to any one of 14 to 22, the method further including:

determining a position of another person who is present based on the presence information in a case where the target person is not determined; and

controlling the telephone allowed to ring based on the position of the other person who is present determined.

24. The telephone control method executed by a computer according to any one of 14 to 22, the method further including:

causing a representative telephone set in advance to ring in a case where the target person is not determined.

25. The telephone control method executed by a computer according to any one of 14 to 24, the method further including:

deciding the telephone allowed to ring using a comparison result of the position of the target person determined and data including position information of a telephone in the facility.

26. The telephone control method executed by a computer according to any one of 14 to 25, the method further including:

not causing any telephone to ring in a case where the presence information corresponding to the target person indicates absence.

27. A program for causing at least one computer to execute the telephone control method according to any one of 14 to 26.

This application claims priority based on Japanese Patent Application No. 2018-020965 filed on Feb. 8, 2018, the entire disclosure of which is incorporated herein.

1. A telephone control system comprising:
a person determination unit that determines a target person based on a caller number included in a call;
a position determination unit that determines a position of the target person using presence information of a person in a facility; and
a control unit that controls a telephone allowed to ring, based on the position of the target person determined by the position determination unit.

2. The telephone control system according to claim 1, further comprising:
a presence information generation unit that generates the presence information based on a result of face recognition using an image of the person in the facility.

3. The telephone control system according to claim 1, further comprising:
a target person information generation unit that generates target person information defining a target person for each caller number based on a record of responding to a person related to each caller number,
wherein the person determination unit determines the target person corresponding to the caller number included in the call based on the target person information.

4. The telephone control system according to claim 3,
wherein the target person information generation unit generates the target person information based on a history of a responder for each caller number.

5. The telephone control system according to claim 4,
wherein the target person information generation unit decides the target person for each caller number based on a statistical value of durations of a call for each responder obtained from the history.

6. The telephone control system according to claim 4,
wherein the target person information generation unit decides the target person for each caller number based on a statistical value of the number of calls for each responder obtained from the history.

7. The telephone control system according to claim 4,
wherein the target person information generation unit determines the responder to be in correspondence with a caller number based on a result of voiceprint recognition using a call voice.

8. The telephone control system according to claim 4,
wherein the target person information generation unit determines the responder to be in correspondence with a caller number based on an analysis result of a face image of a person.

9. The telephone control system according to claim 3,
wherein the target person information generation unit generates the target person information using a history of email communication with the person related to each caller number.

10. The telephone control system according to claim 1,
wherein the position determination unit determines a position of another person who is present based on the presence information in a case where the target person is not determined by the person determination unit, and
wherein the control unit controls the telephone allowed to ring, based on the position of the other person who is present determined by the position determination unit.

11. The telephone control system according to claim 1,
wherein the control unit causes a representative telephone set in advance to ring in a case where the target person is not determined by the person determination unit.

12. The telephone control system according to claim 1,
wherein the control unit decides the telephone allowed to ring using a comparison result of the position of the target person determined by the position determination unit and data including position information of a telephone in the facility.

13. The telephone control system according to claim 1,
wherein the control unit does not cause any telephone to ring in a case where the presence information corresponding to the target person indicates absence.

14. A telephone control method executed by a computer, the method comprising:
determining a target person based on a caller number included in a call;
determining a position of the target person using presence information of a person in a facility; and
controlling a telephone allowed to ring based on the position of the target person determined.

15-26. (canceled)

27. A non-transitory computer readable medium storing a program for causing at least one computer to execute a telephone control method, the method comprising:
determining a target person based on a caller number included in a call;
determining a position of the target person using presence information of a person in a facility; and
controlling a telephone allowed to ring based on the position of the target person determined.
